(19) United States
(12) Patent Application Publication
(10) Pub. No.: US 2012/0183095 A1
(43) Pub. Date: Jul. 19, 2012

(54) APPARATUS AND METHOD FOR SIGNALLING CARRIER COMBINATION CAPABILITIES FOR A MULTI-CARRIER MULTI-BAND WIRELESS COMMUNICATION SYSTEM

(75) Inventors: Aziz Gholmieh, Del Mar, CA (US); Nathan Edward Tenny, Poway, CA (US); Ravi Agarwal, San Diego, CA (US)

(73) Assignee: QUALCOMM INCORPORATED, San Diego, CA (US)

(21) Appl. No.: 13/352,261

(22) Filed: Jan. 17, 2012

Related U.S. Application Data
(60) Provisional application No. 61/433,609, filed on Jan. 18, 2011.
(60) Provisional application No. 61/442,349, filed on Feb. 14, 2011.

(51) Int. Cl. H04L 27/00

(52) U.S. Cl. 375/295; 375/340

(57) ABSTRACT

An apparatus, method, and computer program product for generating and correspondingly decoding an information element adapted to encode a set of supported carrier combinations for a user equipment in a dual-band multi-carrier wireless communication system. Here, the information element corresponds to a geometric representation of the set of supported carrier combinations, such as a grid that has a first axis corresponding to a first band, and a second axis corresponding to a second band. This way, the grid includes a plurality of cells, each cell representing a carrier combination in the first band and the second band.

### CROSS-REFERENCE TO RELATED APPLICATIONS

This application claims priority to and the benefit of provisional patent application No. 61/433,609, filed in the United States Patent and Trademark Office on Jan. 18, 2011, and provisional patent application No. 61/442,349, filed in the United States Patent and Trademark Office on Feb. 14, 2011, the entire contents of which are incorporated herein by reference.

### BACKGROUND

1. Field

Aspects of the present disclosure relate generally to wireless communication systems, and more particularly, to encoding control signaling representing a configuration in a multi-band multi-carrier wireless communication system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, carrier aggregation is a strategy for increasing the data rates of wireless transmissions by increasing the bandwidth utilized, e.g., by enabling a receiver to receive multiple carriers in simultaneous transmissions. Recently, further enhancements in equipment have enabled carrier aggregation of one or more carriers transmitted in different bands. As such systems are deployed in some regions but not others, it may be advantageous for wireless equipment to signal its capability to support various configurations of carriers in the available bands.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication operable at a user equipment. Here, the method includes generating an information element encoding a set of supported carrier combinations for the user equipment in a dual-band multi-carrier wireless communication system. The information element corresponds to a geometric representation of the set of supported carrier combinations. Further, the method includes transmitting the information element on an uplink channel.

Another aspect of the disclosure provides a method for decoding an information element representing a set of supported carrier combinations in a dual-band multi-carrier wireless communication system. Here, the method includes receiving the information element from a user equipment, initializing a two-variable counter, including a first variable and a second variable, to an initial value, determining a value of a bit in the received information element, and altering the first variable when the value of the bit is 1, and altering the second variable when the value of the bit is 0.

Another aspect of the disclosure provides a user equipment (UE) configured for wireless communication. Here, the UE includes at least one processor, a memory coupled to the at least one processor, and a transmitter coupled to the at least one processor for transmitting an uplink channel. The at least one processor is configured to generate an information element encoding a set of supported carrier combinations for the user equipment in a dual-band multi-carrier wireless communication system, the information element corresponding to a geometric representation of the set of supported carrier combinations, and to transmit the information element on the uplink channel.

Another aspect of the disclosure provides an apparatus for decoding an information element representing a set of supported carrier combinations in a dual-band multi-carrier wireless communication system. Here, the apparatus includes at least one processor and a memory coupled to the at least one processor. The at least one processor is configured to receive the information element from a user equipment, to initialize a two-variable counter, including a first variable and a second variable, to an initial value, to determine a value of a bit in the received information element, and to alter the first variable when the value of the bit is 1, and alter the second variable when the value of the bit is 0.

Another aspect of the disclosure provides a computer program product operable at a user equipment. Here, the computer program product includes a computer-readable medium having instructions for causing a computer to generate an information element encoding a set of supported carrier combinations for the user equipment in a dual-band multi-carrier wireless communication system, the information element corresponding to a geometric representation of the set of supported carrier combinations, and instructions for causing a computer to transmit the information element on an uplink channel.

Another aspect of the disclosure provides a computer program product for decoding an information element representing a set of supported carrier combinations in a dual-band multi-carrier wireless communication system. Here, the computer program product includes a computer-readable medium having instructions for causing a computer to receive the information element from a user equipment, instructions for causing a computer to initialize a two-variable counter, comprising a first variable and a second variable, to an initial value, instructions for causing a computer to determine a value of a bit in the received information element, and instructions for causing a computer to alter the first variable when the value of the bit is 1, and to alter the second variable when the value of the bit is 0.

Another aspect of the disclosure provides a UE configured for wireless communication. Here, the UE includes means for generating an information element encoding a set of supported carrier combinations for the user equipment in a dual-band multi-carrier wireless communication system, the information element corresponding to a geometric representation of the set of supported carrier combinations, and means for transmitting the information element on an uplink channel.

Another aspect of the disclosure provides an apparatus for decoding an information element representing a set of supported carrier combinations in a dual-band multi-carrier wireless communication system. Here, the apparatus includes means for receiving the information element from a user equipment, means for initializing a two-variable counter, comprising a first variable and a second variable, to an initial value, means for determining a value of a bit in the received information element, and means for altering the first variable when the value of the bit is 1, and altering the second variable when the value of the bit is 0.

These and other aspects of the invention will become more fully understood upon a review of the detailed description, which follows.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram of a user equipment capable of receiving multiple downlink carriers in a dual-band multi-carrier wireless communication system.

FIG. 6 is a schematic illustration of a geometric representation of carrier combinations in a dual-band multi-carrier wireless communication system.

FIG. 7 is a schematic illustration of a simplification for encoding an information element representing supported carrier combinations in a dual-band multi-carrier wireless communication system.

FIG. 8 is a schematic illustration of a process for encoding an information element representing supported carrier combinations in a dual-band multi-carrier wireless communication system.

FIG. 9 is schematic illustration of a process for encoding an information element representing supported carrier combinations in a dual-band multi-carrier wireless communication system having a hole in one of the bands.

FIG. 10 is schematic illustration of a process for encoding an information element representing supported carrier combinations in a dual-band multi-carrier wireless communication system having a hole in each of the bands.

FIG. 11 is a flow chart illustrating a process for encoding an information element representing supported carrier combinations in a dual-band multi-carrier wireless communication system.

FIG. 12 is flow chart illustrating a process for decoding an information element representing supported carrier combinations in a dual-band multi-carrier wireless communication system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

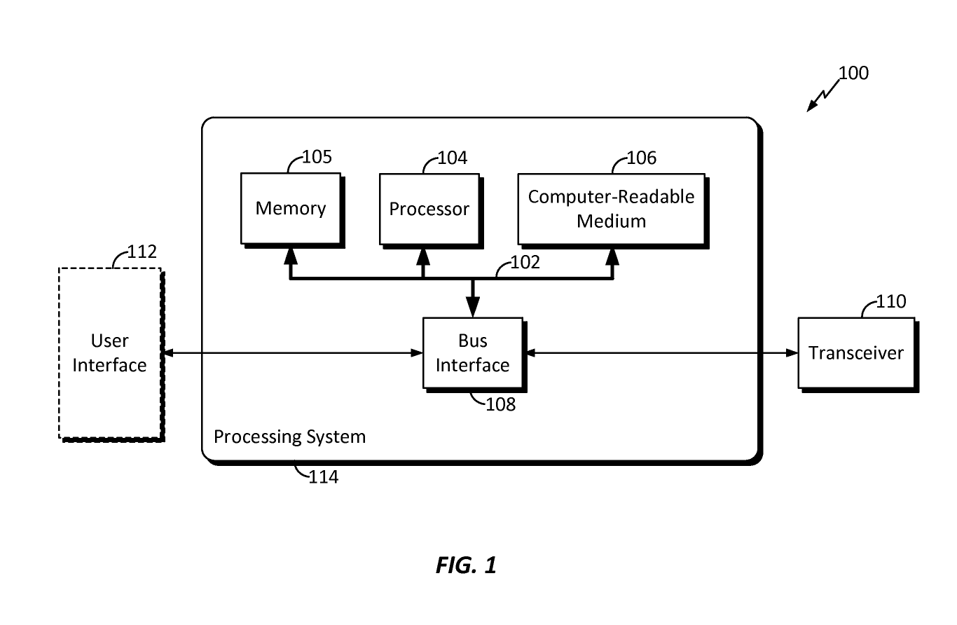

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

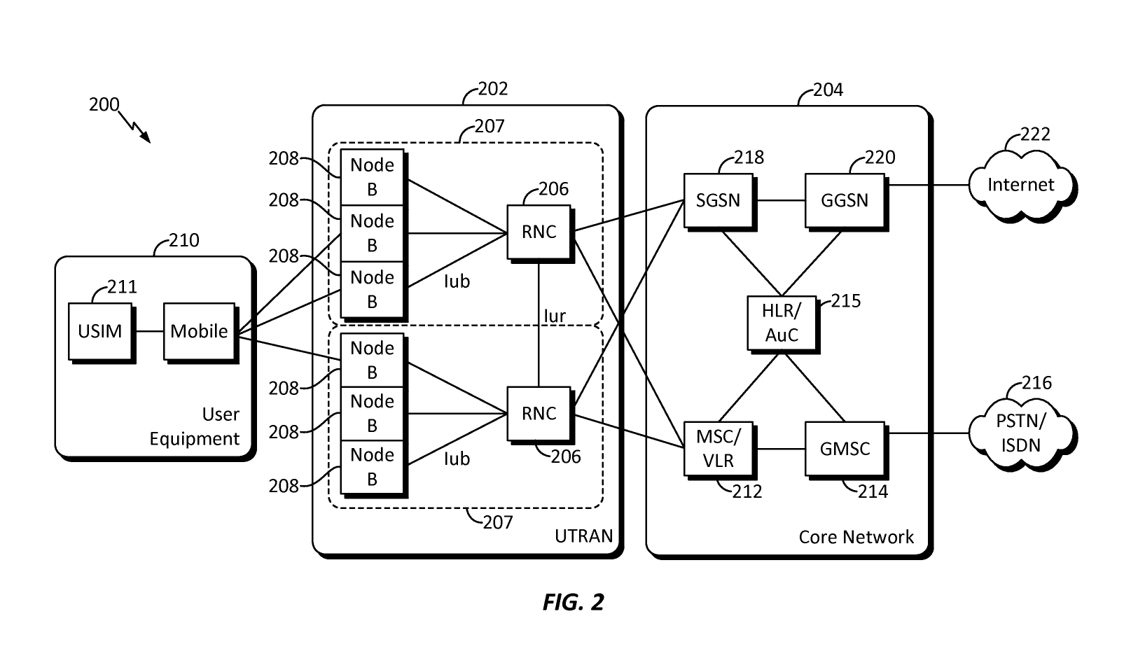

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

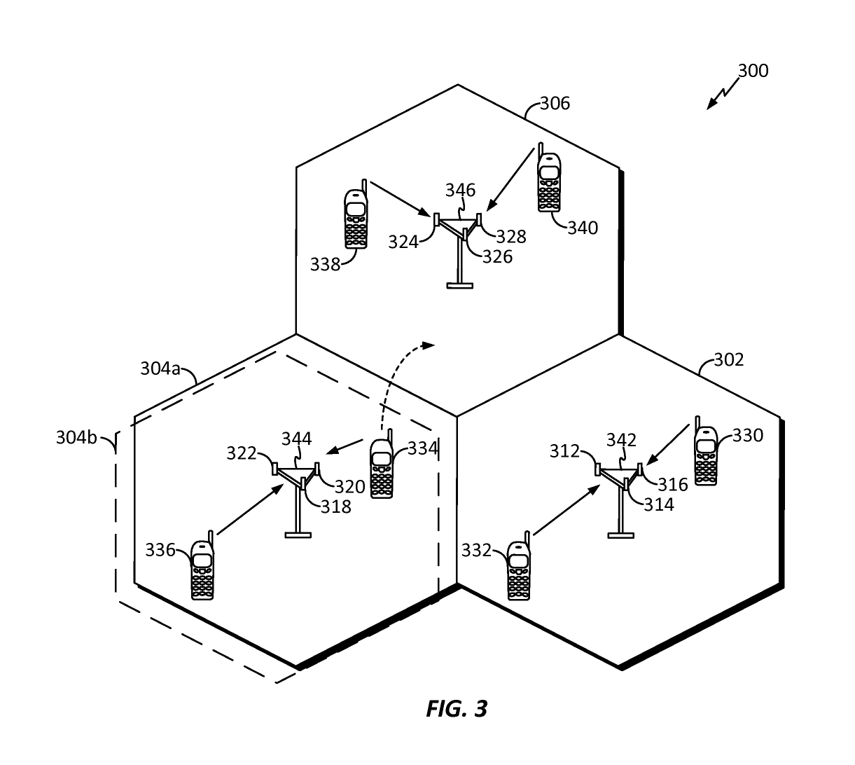

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with characteristics such as a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to a core network 204 (see FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set, that is, a list of cells to which the UE 336 is simultaneously connected (i.e., the UTRAN cells that are currently assigning a downlink dedicated physical channel DPCH or fractional downlink dedicated physical channel F-DPCH to the UE 336 may constitute the Active Set).

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 210 and the core network 204 (referring to FIG. 2), and may include circuit switched and packet switched protocols. The AS provides the lower layers, for signaling between the UTRAN 202 and the UE 210, and may include a user plane and a control plane. Here, the user plane or data plane carries user traffic, while the control plane carries control information (i.e., signaling).

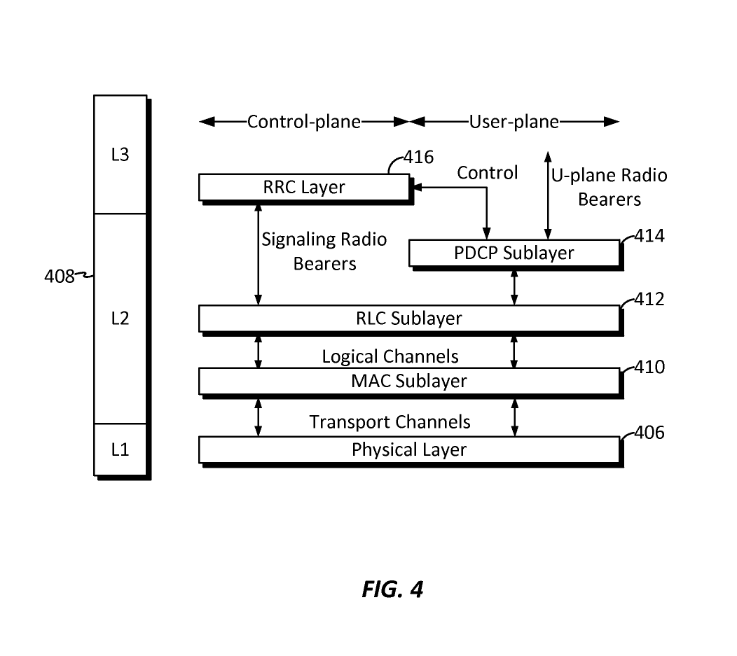

Turning to FIG. 4, the AS is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 408, is above the physical layer 406 and is responsible for the link between the UE 210 and Node B 208 over the physical layer 406.

At Layer 3, the radio resource control (RRC) layer 416 handles the control plane signaling between the UE 210 and the Node B 208. RRC layer 416 includes a number of functional entities for routing higher layer messages, handling broadcasting and paging functions, establishing and configuring radio bearers, etc. The detailed functionality of the RRC layer 416 is specified in 3GPP TS 25.331, Radio Resource Control (RRC); Protocol Specification, which is publicly available and incorporated herein by reference. In some aspects of the present disclosure, RRC signaling may carry an information element that encodes a set of supported carrier combinations in a dual-band multi-carrier wireless communication system, as described herein below.

In the illustrated air interface, Layer 2 408 is split into sublayers. In the control plane, the Layer 2 408 includes two sublayers: a medium access control (MAC) sublayer 410 and a radio link control (RLC) sublayer 412. In the user plane, the Layer 2 408 additionally includes a packet data convergence protocol (PDCP) sublayer 414. Although not shown, in the NAS the UE 210 may have several upper layers above Layer 2 408 including a network layer (e.g., IP layer) that is terminated at a PDN gateway on the network side and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC sublayer 410.

The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

A high speed packet access (HSPA) air interface includes a series of enhancements to the 3G/W-CDMA air interface between the UE 210 and the UTRAN 202, facilitating greater throughput and reduced latency for users. Among other modifications over prior standards, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink or EUL).

For example, in Release 5 of the 3GPP family of standards, HSDPA was introduced. HSDPA utilizes as its transport channel the high-speed downlink shared channel (HS-DSCH), which may be shared by several UEs. The HS-DSCH is implemented by three physical channels: the high-speed physical downlink shared channel (HS-PDSCH), the high-speed shared control channel (HS-SCCH), and the high-speed dedicated physical control channel (HS-DPCCH).

The HS-SCCH is a physical channel that may be utilized to carry downlink control information related to the transmission of HS-DSCH. Here, the HS-DSCH may be associated with one or more HS-SCCH. The UE 210 may continuously monitor the HS-SCCH to determine when to read its data from the HS-DSCH and to determine the modulation scheme used on the assigned physical channel.

The HS-PDSCH is a physical channel that may be shared by several UEs and may carry downlink data for the high-speed downlink. The HS-PDSCH may support quadrature phase shift keying (QPSK), 16-quadrature amplitude modulation (16-QAM), and multi-code transmission.

The HS-DPCCH is an uplink physical channel that may carry feedback from the UE 210 to assist the Node B 208 in its scheduling algorithm. The feedback may include a channel quality indicator (CQI) and a positive or negative acknowledgement (ACK/NAK) of a previous HS-DSCH transmission.

Release 8 of the 3GPP standards for UMTS introduced dual carrier HSDPA (DC-HSDPA), which enables a UE 210 to aggregate two adjacent 5-MHz downlink carriers transmitted by a Node B 208. The dual carrier approach provides higher downlink data rates and better efficiency at multicarrier sites. Generally, DC-HSDPA utilizes a primary carrier and a secondary carrier, where the primary carrier provides channels for downlink data transmission and channels for uplink data transmission and the secondary carrier provides a second set of HS-PDSCHs and HS-SCCHs for downlink communication. Here, the primary carrier is generally the best serving HS-DSCH cell according to measurements by the UE 210 of the energy of pilot transmissions from nearby cells.

As discussed above, DC-HSDPA provides for downlink carrier aggregation. The carrier aggregation achieved in 3GPP Release 8 DC-HSDPA and its subsequent enhancements provides benefits in terms of user experience, including latency reduction for bursty traffic. As the UMTS standards continue to evolve, carrier aggregation of more than two carriers has been introduced, generally referred to as multi-carrier HSDPA (MC-HSDPA). Thus, in accordance with various aspects of the present disclosure, any suitable number of downlink carriers may be utilized in a wireless communication system.

In any particular UE, its capability to support a certain number of carriers generally depends on its own physical layer configuration. For example, to be able to receive two carriers simultaneously, the UE 210 may require two receive chains at the physical layer.

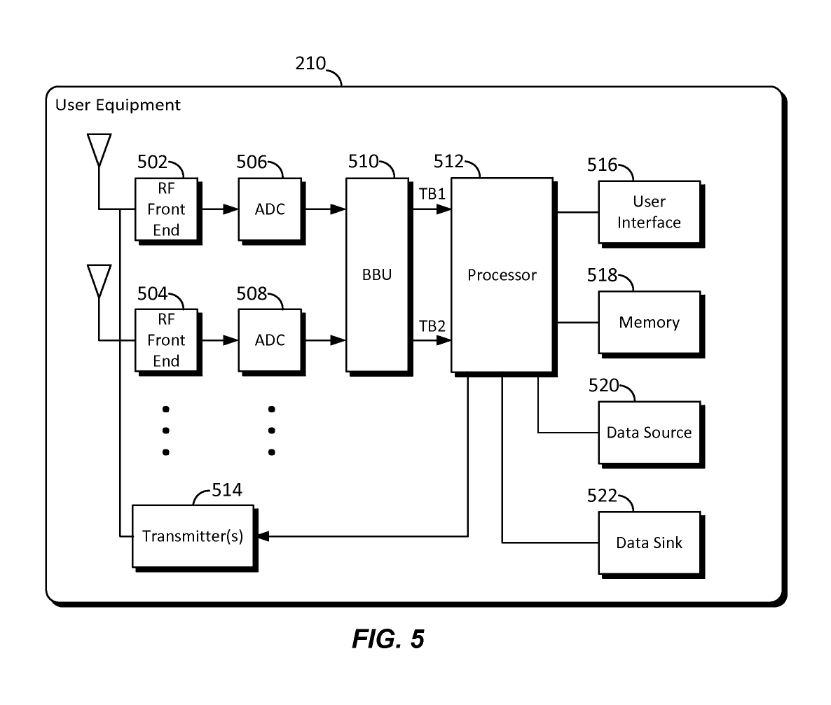

FIG. 5 is a simplified block diagram illustrating some of the components of an exemplary UE 210 for use in a MC-HSDPA network in accordance with some aspects of the present disclosure. In the illustration, the UE 210 includes N receive antennas for receiving respective downlink signals in the MC-HSDPA network. That is, within the scope of the present disclosure, a UE 210 may include any number of antennas for receiving downlink signals in the same carrier frequency or in any suitable number of different carrier frequencies.

Coupled to each of the antennas may be a respective RF front end 502, 504. The RF front end may include such functional blocks as diplexers, RF down-conversion, low-pass filtering, etc. Here, the diplexers can enable the sharing of antennas across bands, as described in further detail below. The RF front end then feeds into an analog to digital converter 506, 508, which may transform the received downlink channels to the digital domain to be further processed by a base-band unit or BBU 510. The BBU 510 may include such functional blocks as carrier/antenna separation, a base-band detector, and a base-band decoder, configured to provide the received transport blocks (TBs) to a processor 512 to be further processed in accordance with the received information. In some examples, the processor 512 may be the same as the processing system 114 illustrated in FIG. 1.

The processor 512 may additionally be coupled to one or more transmitters 514, which may utilize one or more of the UE's antennas as managed by a suitable duplexer. The processor 512 may additionally utilize a memory 516 for storing information useful for the processing of the information.

Further, the processor 512 may be coupled to a user interface 518, which may include one or more of a display device, a keyboard, a touch screen, a microphone, a speaker, or any other suitable means for interfacing between a user and the processor 512. The processor 512 may additionally be coupled to one or more of a data source 520 and/or a data sink 522. Here, the data source/sink may include an interface such as a wired or wireless communication port for transmitting and/or receiving information to another device to/from the user equipment 210. A wired interface may be a serial interface such as a standard USB port, a parallel interface, etc.; a wireless interface may be a personal area network interface such as a Bluetooth interface, etc.

Conventionally, a MC-HSDPA system generally may be limited to providing all the carriers to the UE 210 within a single frequency band. Here, the term “carrier” may refer to a 5-MHz portion of spectrum utilized to carry a set of communication channels, as is standard in UMTS. However, the 5-MHz characteristic is not intended to be limiting, and a carrier may have any suitable bandwidth in accordance with aspects of the present disclosure. The term “band” may refer to any arbitrary portion of electromagnetic spectrum available for use in a wireless communication system. For example, in the United States, UMTS can utilize the 1900 MHz “PCS” band (1850-1910 MHz), the 1700 MHz “AWS” band (1710-1755 MHz), the 850 MHz “CLR” band (824-849 MHz), the 2600 MHz “IMT-E” band (2500-2570 MHz), among others, although the distribution of bands of the wireless spectrum that might be available in any region can be different, and in any particular region, can change over time. In general, a band may be divided into a number of carriers for use in the wireless communication system. That is, carriers are generally a subset within each available band.

In 3GPP Release 11 specifications for UMTS, the UE 210 may support up to eight carriers on the downlink for HSDPA, where the carriers may be distributed over two bands. In the present disclosure, this scheme is referred to as dual-band 8-carrier HSDPA (DB-8C-HSDPA). In accordance with various aspects of the present disclosure, the UE 210 may be configured to signal to the UTRAN 202 the UE's capability of supporting a particular set of those carriers across the two bands. Of course, the DB-8C-HSDPA scheme is only one example that may benefit from the signaling disclosed in the present disclosure. Those of ordinary skill in the art will recognize that the concepts disclosed herein may be generalized to apply to any dual-band, multi-carrier system wherein carrier support capabilities are desired to be signaled from one node to another.

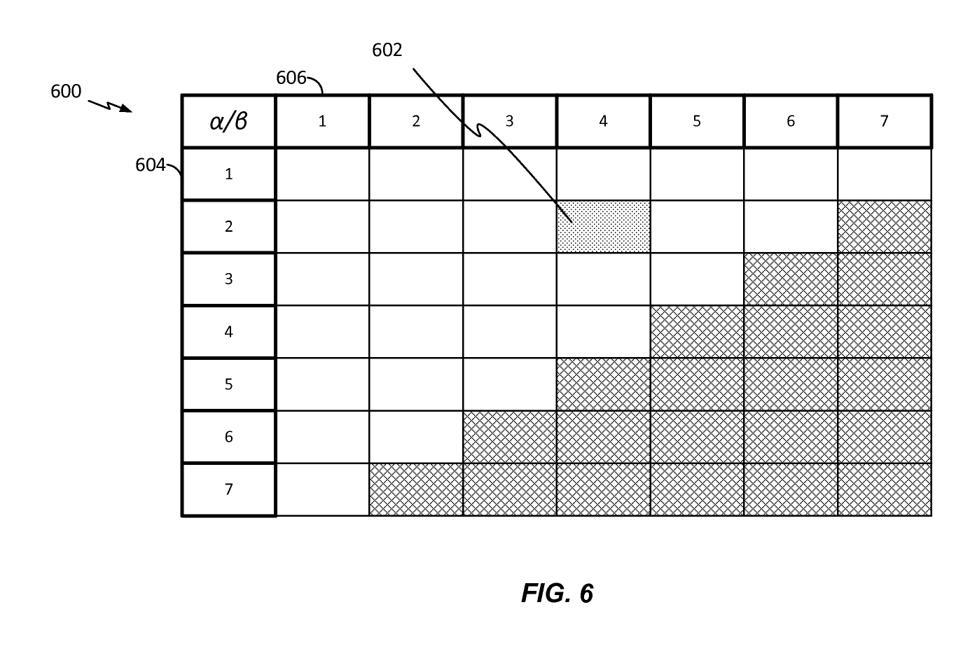

FIG. 6 illustrates a grid 600 that provides a geometric representation of all possible carrier configurations in a DB-8C-HSDPA system. In the geometric representation, a first axis 604 corresponding to a first band represented by the symbol a extends in the vertical direction, and a second axis 606 corresponding to a second band represented by the symbol β extends in the horizontal direction. Here, the bands α and β are not intended to represent any particular band, but in a specific implementation they may each represent any suitable band in a DB-8C-HSDPA system. In the exemplary DB-8C-HSDPA system, the sum of the carriers supported on band α and the carriers supported on band β may be no greater than 8 total carriers. That is, if A represents the number of carriers the UE 210 is capable of supporting on band α, and if B represents the number of carriers the UE 210 is capable of supporting on band β, then A+B≦8.

Of course, due to operator configuration of the UE 210, or for any suitable reason, the actual number of carriers the UE 210 may wish to utilize for a particular call may be less than the full capabilities of the UE 210. For example, although a UE 210 may be capable of supporting seven carriers on band α, in a certain scenario the UE 210 may only utilize three carriers on band α. Generally, x may represent the number of carriers the UE 210 utilizes in band α in a particular configuration, and y may represent the number of carriers the UE 210 utilizes in band β in a particular configuration.

Further, to maintain the dual-band characteristic, it may be assumed that at least one carrier is supported on each band. Therefore, in an eight-carrier system, the UE 210 may support up to seven carriers in each band. Thus:

A+B≦8.

1≦x≦A≦7.

1≦y≦B≦7.

Referring to FIG. 6, the carriers available on band α and the carriers available on band β are each numbered 1-7. Thus, each cell, at an intersection of a number from band α and a number from band β is utilized to represent a particular configuration corresponding to that number of carriers in the respective band. As an illustrative example, shaded rectangle 602 represents a carrier combination with two carriers on band α, and four carriers on band β. In the present disclosure, this cell is represented with the notation (2, 4).

The rectangles in FIG. 6 that are not filled with the cross-hatch pattern therefore represent all possible carrier combinations across bands α and β in a DB-8C-HSDPA system according to the characteristics described above. It can be seen from this illustration that there are 7*(7+1)/2=28 possible carrier combinations in the DB-8C-HSDPA system, as represented by the rectangles that are not filled with the cross-hatch pattern. It should be clear that the schematic illustration is only intended to represent a number of carriers, and is not intended to restrict support to any particular carrier within the indicated band. That is, referring once again to FIG. 5, it may be assumed that the number of supported carriers corresponds to the number of receive chains 502, 504, etc. that exist in the UE 210, and each of the respective receive chains may be tuned or otherwise configured to receive downlink channels on any suitable carrier frequency as needed in a particular configuration.

As described above, various aspects of the present disclosure provide an information element that encodes a particular set of carrier combinations that might be supported in a DB-8C-HSDPA system. In one example, a straightforward signaling can be utilized with one bit representing each available carrier combination. In this example, because there are 28 possible carrier combinations in the DB-8C-HSDPA system, a 28-bit symbol could be utilized, where each bit represents a particular carrier combination (i.e., a particular rectangle in the geometric representation shown in FIG. 6).

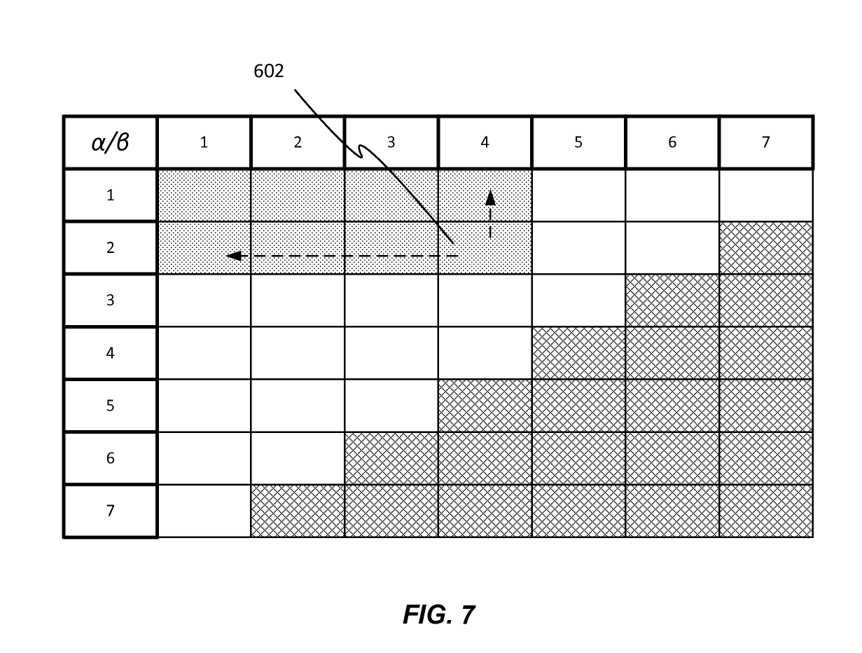

However, it may be desired to reduce the length of the signaling utilized, to be shorter than 28 bits. A reduction in the length of the signaling may be achieved by recognizing certain properties of the DB-8C-HSDPA system, assisted by the schematic illustrations included herein. That is, in an aspect of the present disclosure, if a particular carrier combination (x, y) is supported by a UE 210, then it may be implied that the UE 210 also supports all carrier combinations smaller than (x, y). For example, referring now to FIG. 7, if the carrier combination (2, 4) 602 described above is supported, then it may be implied that the UE 210 also supports all carrier combinations smaller than (2, 4), indicated by the shaded rectangles. Thus, in some examples according to this aspect of the disclosure, a UE's support of a particular carrier combination, represented as illustrated, may be taken to imply that the UE 210 supports all carrier combinations in the rectangular region bounded with one corner at that particular carrier combination, and the opposite corner at the carrier combination (1, 1).

Thus, having this property, it would be redundant to utilize the 28-bit signaling described above to represent all supported carrier combinations in a DB-8C-HSDPA system. That is, if the 28-bit signaling were utilized, and if the bit representing the carrier combination (2, 4) 202 were asserted, then the bits representing the carrier combinations (1, 1), (1, 2), (1, 3), (1, 4), (2, 1) (2, 2) and (2, 3) would all be redundant and would not provide any additional information. Thus, aspects of the present disclosure take advantage of this property to improve the efficiency of the encoding utilized to indicate supported carrier combinations.

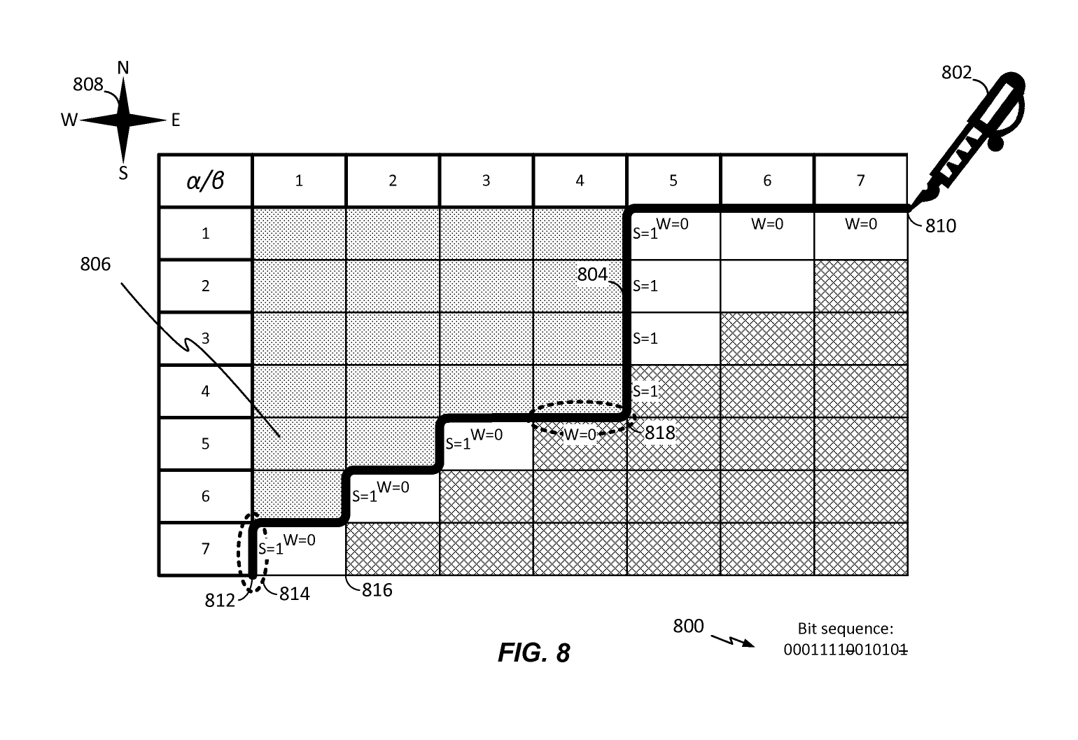

To conceptualize the paradigm that leads to the encoding provided in various aspects of the present disclosure, FIG. 8 utilizes a “pen” 802 to draw a line bounding outer edges of the region indicating all supported carrier combinations for a particular configuration. Of course, the pen 802 is not an actual pen and is merely an abstraction utilized to illustrate the encoding of a set of supported carrier combinations in accordance with various aspects of the present disclosure. In the illustrated example, the pen 802 may begin at the top-right corner 810 of the illustration and may move down and to the left along the boundary of the region that includes the supported carrier combinations to draw the line 804.

As one example, a set of supported carrier combinations in a particular configuration may be represented by the shaded region 806 in FIG. 8. Thus, the pen 802, beginning at the top-right corner 810, may begin by moving to the left (e.g., towards the “west” according to the compass 808), represented in this example by a “0” bit. In this example, the pen 802 moves west, or to the left, for three spaces (carriers), represented by three leading 0s. Here, where the pen meets the boundary 804 of the region 806 representing supported carrier combinations, the pen moves south, or downward in the illustration, by four spaces (carriers), represented by four 1s following the three leading 0s. In this fashion, the pen 802 traces the boundary 804 of the region 806 representing supported carrier combinations.

As described above, because the support of a particular carrier combination (x, y) may imply support for all carrier combinations smaller than (x, y), this boundary 804 can completely characterize the region 806 representing all supported carrier combinations.

As a further property, because the support of a particular carrier combination (x, y) may imply support for all carrier combinations smaller than (x, y), it follows that the pen 802, when it begins its path at the top-right corner 810 of the diagram of FIG. 8, need only move in the “west” and “south” directions as it traces the boundary 804 of the region 806 representing all supported carrier combinations. Thus, the boundary 804 may be characterized as a monotonic staircase.

In an aspect of the present disclosure, when the pen 802 begins at the top-right corner 810, in a DB-8C-HSDPA system, the pen 802 will trace out seven 1s and seven 0s to fully circumscribe the region 806 representing all supported carrier combinations, completing its path at an opposite corner to the top-right corner 810, that is, at the lower-left corner 812. Thus, the boundary 804 corresponding to the information element 800 corresponds to that boundary from a first corner 810 of the grid 600 to a second corner 812 of the grid 600 that is opposite to the first corner 810. Here, an opposite corner is a corner diagonally opposed to the other corner in the grid 600.

For example, the illustrated path 804 traces out the sequence: 00011110010101. Thus, this sequence may be utilized as an information element 800 encoding a set of supported carrier combinations of (α,β)=(1, 1); (2, 1); (3, 1); (4, 1); (5, 1); (6, 1); (1, 2); (2, 2); (3, 2); (4, 2); (5, 2); (1, 3); (2, 3); (3, 3); (4, 3); (1, 4); (2, 4); (3, 4); and (4, 4). Thus, any possible configuration supporting a set of carrier combinations may be represented by a 14-bit sequence.

In a further aspect of the present disclosure, the information element 800 may easily be shortened to 13 bits when it is recognized that the ultimate, 14th bit in the bit sequence, adjacent to the lower-left corner 812, is always known based on the previous 13 bits. For example, in the illustration of FIG. 8, the ultimate bit must be a 1, because after 13 bits, the path 804 has already extended across the boundary of the cell representing the carrier combination (6, 1). Therefore, to reach the lower-left corner 812, the ultimate segment 814 of the path 804 must move south. Using this strategy, the region 806 illustrated in FIG. 8 may be represented by an information element 800 having the 13-bit sequence 0001111001010. Similarly, if in a different configuration the path traced were to reach the point 816 at the bottom of the diagram, then the path must move westward to reach the lower-left corner 812. In this case, it would be known that the ultimate, 14th bit would be a 0. Thus, in any configuration, all supported carrier combinations may be represented by a 13-bit sequence as described herein above.

Of course, one may recognize that at any time the pen 802 reaches the far-left boundary of the diagram, it may be known that all the remaining bits must be 1s, since the pen 802 must move southward to reach the lower-left corner 812. Thus, an aspect of the present disclosure may shorten the sequence to less than 13 bits, with the bit length depending on how many trailing 1s may be truncated (e.g., how many 1s are at the end of the sequence). However, in such an example, it may be desirable for the entity receiving the bit sequence to know the length of the sequence. In this case, the length may be up to 13 bits, so it is likely that at least 3 additional bits would be added to the sequence to indicate a length of the sequence. Here, depending on how frequently the length of the sequence may be truncated by more than 3 bits, this additional length indicator may or may not be desirable.

Similarly, a receiving entity decoding the corresponding information element 800 may recognize that the pen 802 reached the far-left of the diagram by detecting that seven 0s have been signaled. In this case, the receiving entity may simply ignore any trailing bits upon detecting that the seven 0s have been signaled, by assuming that since the pen 802 reached the far-left of the diagram, then any trailing bits must be 1s for the pen 802 to reach the lower-left corner 812.

In a further aspect of the present disclosure, when the pen 802 reaches a point such as point 818 at a boundary of the cross-hatch region (i.e., the region containing carrier combinations that are not possible to support in a DB-8C-HSDPA system), a bit may be omitted without losing any information. For example, in the illustrated example in FIG. 8, after traversing the first seven bits (i.e., after tracing out the pattern 0001111), the pen 802 has no option other than to move westward, or else it would enter into the cross-hatch region, which is not allowed. Thus, in an aspect of the disclosure, the entity encoding the information element for signaling the set of supported carrier combinations may skip the following bit (i.e., the 0 bit indicating a westward movement of the pen 802) because that movement may be implied. Accordingly, a receiving entity decoding the signaling may infer the existence of the omitted bit based on the previous bits, since during the decoding of the string, the decoding entity may recognize that the pen 802 has reached the boundary of the supportable carrier combinations, and a movement other than the westward movement of the pen 802 would result in a disallowed carrier combination. In this fashion, the encoding of the signaling can result in a further reduction in the length of the string.

In a further aspect of the present disclosure, a plurality of different sets of supported carrier combinations may be possible in a UE 210 that supports more than one mode of operation. For example, a UE 210 that is capable of communicating on a FDD network such as a W-CDMA network, as well as a TDD network such as a TD-SCDMA network, may have different sets of supported carrier combinations on the W-CDMA network and the TD-SCDMA network. While some examples might utilize a single signaled information element indicating supported carrier combinations across all supported technologies for a UE 210, it may be the case that the carriers are numbered or configured differently in different technologies. Similarly, different bands may be allocated for different technologies, so one set of supported carrier combinations may not apply to more than one technology.

Here, in accordance with an aspect of the present disclosure, the UE 210 may be configured to transmit a first information element indicating a first supported set of carrier combinations in the W-CDMA network, and a second information element indicating a second supported set of carrier combinations in the TD-SCDMA network.

In another aspect of the present disclosure, a union of a plurality of information elements may be signaled at once, to indicate supported sets of carrier combinations across a plurality of technologies.

Similarly, a plurality of different radio access technologies (RATs) such as GSM, cdma2000, EV-DO, LTE, WiMAX, etc., may be supported by a particular UE 210, and in these cases, a UE capable of supporting more than one RAT may be configured to transmit information elements signaling supported sets of carrier combinations on any one or more of the RATs supported by the UE.

In a still further aspect of the present disclosure, the signaling described herein may be modified to accommodate a dual band network wherein a hole may exist in one or both of the bands. That is, it is possible that an operator of a dual band network may not own rights to all carriers available in a particular band, yet that operator may still wish to enable multi-carrier aggregation in dual bands. Thus, some aspects of the disclosure provide signaling to indicate a supported set of carrier combinations where the operator wishes to provide non-adjacent carriers within the same band. That is, a “hole” in a band corresponds to one or more adjacent carriers in a band that are unavailable for use in the dual-band multi-carrier wireless communication system.

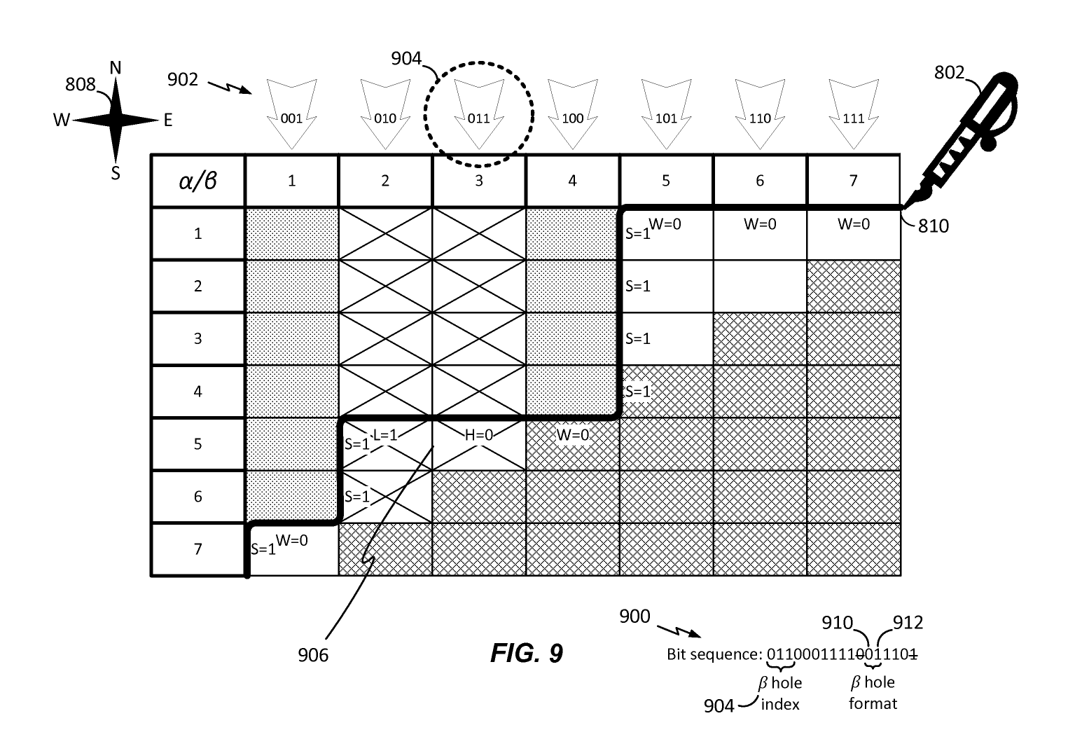

FIG. 9 is an illustration of a scenario wherein a hole 906 two carriers wide exists in band β. In this scenario, the signaling that non-adjacent carriers in band β may be utilized may be accomplished by utilizing an index to point to the beginning of the hole in the band, in conjunction with an escape character to indicate the last empty carrier in the hole in the band.

In the illustrated example, the carriers in the band β are indexed utilizing index labels 902. To index all seven carriers in band β, three bits may be utilized, e.g., from 001 to 111. Of course, the particular sequence of index labels 902 shown in FIG. 9 is only illustrative in nature, and those of ordinary skill in the art will recognize that any suitable sequence may be utilized; and further, any suitable number of bits, not exclusive to the three-bit index labels described here, may be utilized. In this way, in an illustrative example, the index label 902 may be included as a prefix for the bit sequence representing the supported set of carrier combinations.

In the exemplary scenario illustrated in FIG. 9, carriers 2 and 3 are unavailable in band β. Thus, in this example, the hole 906 begins at carrier 3 having index label 904, as indicated by the three-bit binary index 011. Here, the “beginning” of the hole means the first carrier that the pen 802 comes into contact with when it traverses the path, starting at the top-right corner 810 as described above. That is, as the pen 802 traverses the path and traces the pattern 00011110, as described above in relation to FIG. 8, the pen 802 reaches the hole in band β as indicated by the index 904. At this point, the pen 802 extends along a cell in the hole 906, and utilizes a first character 910, such as a 0, to indicate a hole “H” in the band β. According to an aspect of the present disclosure, the pen continues across the hole 906 utilizing the H=0 character for as many characters as it takes to traverse the hole. When the pen 802 reaches the last empty carrier in the hole, in an aspect of the present disclosure, a second character 912 such as a 1 may be utilized to indicate the last empty carrier in the hole. That is, the bit sequence may utilize a first character such as H=0 as the pen 802 traverses the hole, and the bit sequence may utilize an escape character such as L=1 as the pen 802 reaches the last empty carrier in the hole. At this time, after the escape character L=1 has been utilized, the pen 802 may continue to draw the monotonic staircase about the region of supported carrier combinations as described above.

Thus, in the example illustrated in FIG. 9, the bit sequence may be 01100011110011101, indicating the set of supported carrier combinations including carrier combinations (α, β)=(1, 1); (2, 1); (3, 1); (4, 1); (5, 1); (6, 1); (1, 4); (2, 4); (3, 4); and (4, 4). Here, the bit sequence includes the β hole index 011; the monotonic staircase sequence 00011110; the hole format sequence 01; and the monotonic staircase sequence 1101. Of course, as described above, the final bit may be eliminated to shorten the length of the bit sequence, since the final bit is known based on the previous 13 bits.

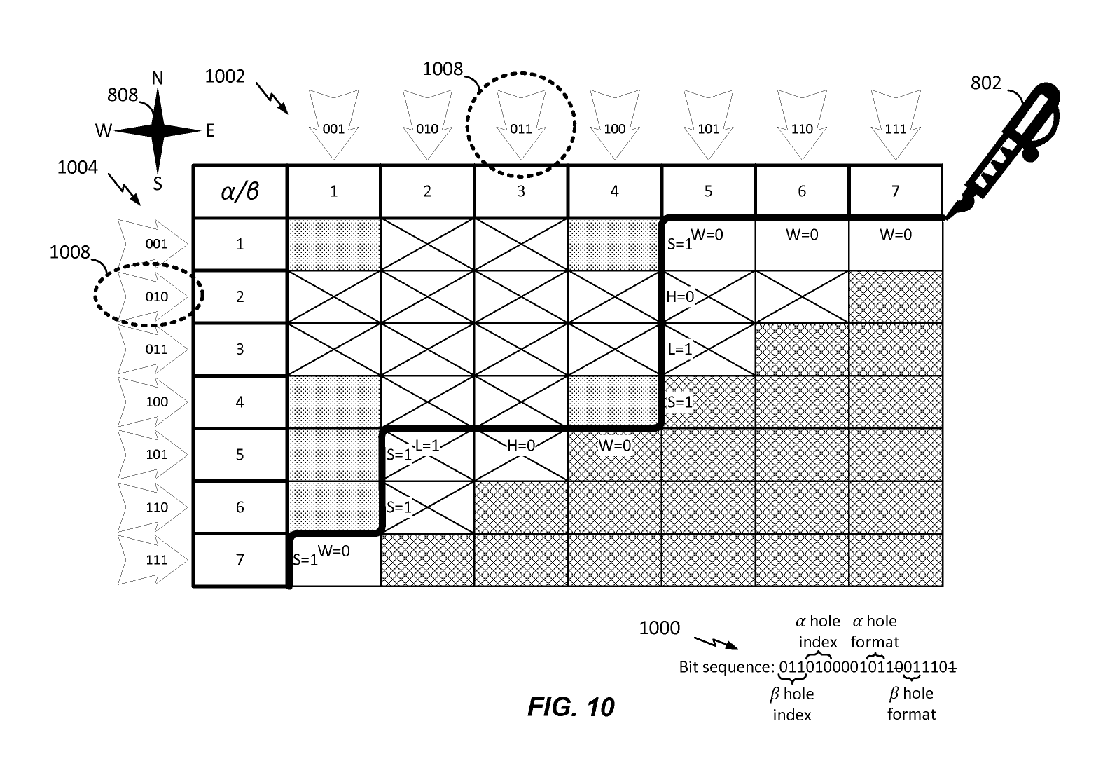

FIG. 10 is an illustration of another aspect of the present disclosure wherein the signaling may be further modified to accommodate a dual band network wherein a hole may exist in both of the bands. That is, both bands α and β may include a hole such that non-adjacent carriers may be utilized in each of the bands. In this example, a first index 1002 may be utilized for the band β, while a second index 1004 may be utilized for the band α. In an illustrative example, the first index 1002 may be included as a first prefix for the bit sequence representing the supported set of carrier combinations, and the second index 1004 may be included as a second prefix for the bit sequence representing the supported set of carrier combinations.

In this way, the pen 802 may begin traversing the monotonic staircase about the boundary of the set of supported carrier combinations, as in the previously described examples. When the pen 802 reaches one of the boundaries corresponding to a hole in a band, such as carrier 2 in band α, as indicated by the carrier index 1008 represented by the α hole index 010, the bit sequence may utilize a first character, such as a 0, until the hole is traversed; at which time the escape character, such as a second character 1, may be utilized to indicate that the last carrier of the hole in the corresponding band α has been traversed. At this time, the bit sequence may continue the monotonic staircase to trace the boundary of the region corresponding to the set of supported carrier combinations, until such a time as the pen 802 reaches the second one of the boundaries corresponding to a hole in the second band β. Here, the pen 802 may traverse the second gap corresponding to the hole in the corresponding band β, utilizing the first character 0, until the hole is traversed; at which time the escape character 1 may be utilized to indicate that the last carrier of the hole in the corresponding band β has been traversed.

Thus, in the example illustrated in FIG. 10, the bit sequence may be 01101000010110011101, indicating the set of supported carrier combinations including the carrier combinations (α,β)=(1, 1); (4, 1); (5, 1); (6, 1); (1, 4); and (4, 4). Here, the bit sequence includes the β hole index 011; the α hole index 010; the monotonic staircase sequence 0001; the α hole format sequence 01; the monotonic staircase sequence 10; the β hole format sequence 01; and the monotonic staircase sequence 1101.

The index and escape character utilized in these illustrated examples are only illustrative in nature, and other signaling to indicate a hole in one or both bands in a dual band network may be utilized within the scope of the present disclosure. For example, an index may be utilized with a symbol representing the size of the hole, rather than the escape character described above.

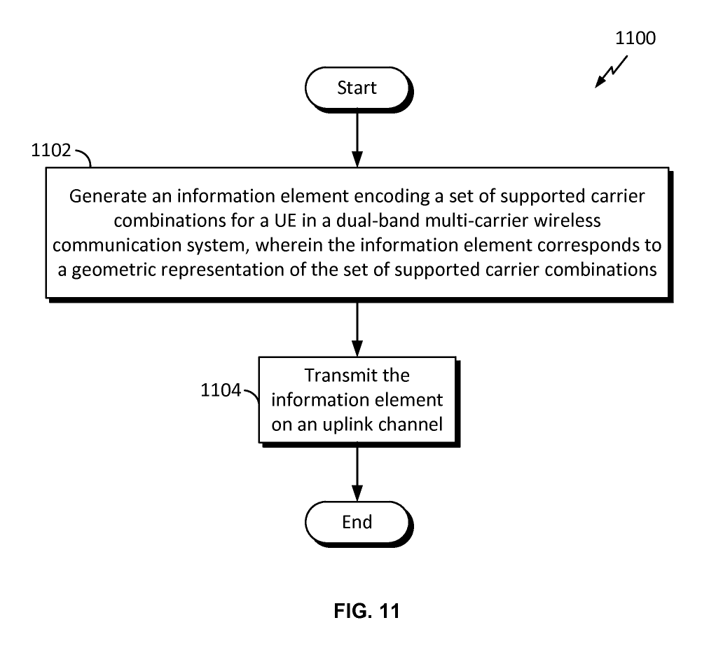

FIG. 11 is a flow chart illustrating a process 1100 for encoding a symbol representing all supported carrier combinations in a DB-8C-HSDPA system in accordance with some aspects of the present disclosure.

In some aspects of the disclosure, the process 1100 may be implemented by one or more processors, such as the processing system 114 illustrated in FIG. 1. In other aspects of the disclosure, the process 1100 may be implemented by a UE 210, or by any suitable node for encoding and/or transmitting signaling indicating supported carrier combinations in a dual band wireless communication system.

At block 1102, the process generates an information element 800 that encodes a set of supported carrier combinations for the UE 210 in a dual-band multi-carrier wireless communication system. Here, the information element 800 corresponds to a geometric representation of the set of supported carrier combinations, such as the grid 600 illustrated in FIG. 6. At block 1104, the process transmits the information element 800 on an uplink channel, for utilization by a network node such as a base station, an RNC, or any suitable node for decoding the information element.

In some aspects of the present disclosure, the starting point from where the pen 802 may begin its path about the supported region may be altered, to begin from a point other than the point 810, in accordance with any one or more of various suitable factors. For example, in some DB-8C-HSDPA networks, one of the bands, such as band β, may have a smaller number of carriers available for a UE to utilize. In another example, the UE itself may only have the capability to support a reduced number of carriers on one of the bands, such as band β. In either of these scenarios, were the pen 802 to begin at the point 810 at the top-right corner of the diagram, it would always include one or more leading zeros, or bits indicating that the UE does not support the largest number of carriers in the band β. Thus, in this case, in accordance with an aspect of the present disclosure the starting point for the pen 802 may accordingly be shifted to the left (i.e., westward according to the compass 808) such that it begins its path at a point corresponding to the largest possible number of supported carriers in band β.

Further, in some dual band networks, a smaller number of carriers than the eight carriers that may be supported in the DB-8C-HSDPA network may be supported. For example, a particular dual band network may only support 4 or 6 carriers per UE, distributed across the two bands. Similarly, a particular UE in any dual band network may only be capable of supporting a smaller number of carriers than might be available in a network. For example, although utilizing a DB-8C-HSDPA network, a particular UE may only have a receiver capable of receiving 4 or 6 carriers distributed across the two bands. In another scenario, although a high number of carriers such as the eight carriers in the DB-8C-HSDPA network might be available, operator restrictions might limit the number of carriers available for use. In any of these scenarios, were the pen 802 to begin at the point 810 at the top-right corner of the diagram, it would always include one or more leading zeros, or bits indicating that the UE does not support the largest number of carriers. That is, in a DB-8C-HSDPA network where a UE might support up to eight carriers distributed across the two bands, it is possible for the UE to support up to seven carriers in the band β. However, in this scenario, according to an aspect of the present disclosure, the pen 802 may begin its path at a point corresponding to the highest number of carriers that the UE supports in either of the bands, minus 1. For example, if the UE supports six carriers distributed across the two bands, the pen 802 may begin its path at a point corresponding to five carriers on the band β.

While various aspects of the present disclosure have been described in detail with reference to a DB-8C-HSDPA network where up to seven carriers might be supported in each of the two bands, those of ordinary skill in the art will recognize that the number of carriers in each band can be varied, still within the scope of the present disclosure. Further, while various aspects of the present disclosure have been described in detail with reference to signaling wherein a 0 represents a westward movement of the pen 802 and a 1 represents a southward movement of the pen 802, those of ordinary skill in the art will recognize that this bit combination is only exemplary in nature and a swapping of the bits utilized in a particular implementation may be utilized such that a 1 represents a westward movement of the pen 802 and a 0 represents a southward movement of the pen 802. Similarly, while various aspects of the present disclosure have been described in detail with reference to signaling representing southward and westward movements of the pen 802, those of ordinary skill in the art will recognize that this restriction is only exemplary in nature and northward and eastward movements of the pen 802 may be represented by the signaling within the scope of the present disclosure.

Further, information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the disclosure and claims.

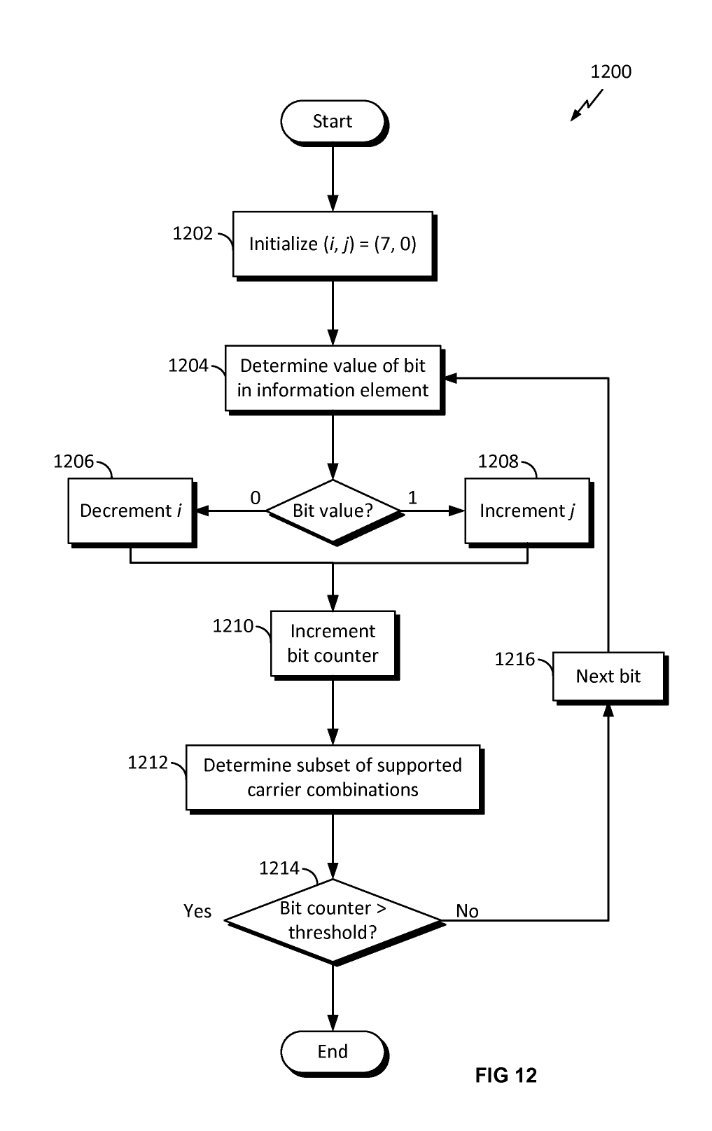

FIG. 12 is a flow chart illustrating an exemplary process 1200 for decoding the information element 800 representing all supported carrier combinations in a DB-8C-HSDPA system in accordance with some aspects of the present disclosure. This process is provided merely as one example, and those of ordinary skill in the art will comprehend that other algorithms can be utilized to decode the information element 800, and any suitable algorithm capable of determining the set of supported carrier combinations represented by the information element 800 may be utilized within the scope of the present disclosure.

In some aspects of the disclosure, the process 1200 may be implemented by one or more processors, such as the processing system 114 illustrated in FIG. 1. In other aspects of the disclosure, the process 1200 may be implemented by a Node B 408, an RNC 406, or by any suitable node for receiving and/or decoding signaling indicating supported carrier combinations in a dual band wireless communication system.

At block 1202, the process may initialize a pair of counter variables (i, j) such that i=N, and j=0. Here, N is the number of carriers the network is capable of providing to the UE in one band. That is, in the DB-8C-HSDPA system, N=7. Referring again to FIG. 8, the initialization of the counter variables may be considered as starting a “pen” 802 at the top-right corner 810, as described above. At block 1204, the process may determine a value of a bit in the information element 800. That is, the first bit in the information element 800 received by a receiving entity that receives the information element 800 may be determined. Referring to the information element shown in FIG. 8 having a value of, e.g., 00011110010101, the first bit has a value of 0, indicating a movement of the pen 802 in a westerly direction. Thus, in this example, at block 1206 the counter variable is changed by decrementing the value of i, such that the counter variable has a value of (i, j)=(6, 0). Of course, in an example wherein the first bit had a value of 1, then at block 1208 the process would increment the value of j.

At this instance, at block 1210, the process increments a bit counter. Here, the bit counter may be a counter of a value corresponding to the number of bits in the information element 800, e.g., having 14 bits in one example. At block 1212, the receiving entity may determine a subset of the supported carrier combinations. That is, the receiving entity may determine that the UE supports all carrier combinations where 1≦β≦i, and α=j. Thus, in this example, as illustrated in FIG. 8, when the counter variable has the value of (6, 0) the UE does not have a supported carrier combination in a dual-carrier network with 6 carriers on band β, since j=0.

Here, the process may proceed to block 1214, where the process may determine whether the bit counter is greater than a threshold. That is, the bit counter may be utilized to determine whether all bits in the information element 800 have been accounted for. If the bit counter is not above the threshold, then in block 1216, the process may proceed to the next bit by, e.g., incrementing the bit counter and returning to block 1204 to determine the value of the next bit in the information element 800. In this way, the value of each

In this fashion, the loop shown in process 1200 may run through a number of iterations corresponding to the bit counter, with each iteration determining another subset, e.g., a row of supported carrier combinations in the grid 600. For example, utilizing the bit sequence in the information element 800, i.e., 00011110010101, the process 1200 would run through one loop for each bit. In this fashion, the counter variable would follow the sequence illustrated in Table 1. In Table 1, each row represents a new bit, appearing underlined, being processed in one iteration of the loop of FIG. 12. The middle column illustrates the updated value of the counter variable (i, j). The third column provides a description of the information provided by certain bits.

TABLE 1

| | | |
|---|---|---|
| Initial Value | (7, 0) | |
| 0 | (6, 0) | |
| 00 | (5, 0) | |
| 000 | (4, 0) | |
| 0001 | (4, 1) | UE supports 1 ≦ β ≦ 4 with α = 1. |
| 00011 | (4, 2) | UE supports 1 ≦ β ≦ 4 with α = 2. |
| 000111 | (4, 3) | UE supports 1 ≦ β ≦ 4 with α = 3. |
| 0001111 | (4, 4) | UE supports 1 ≦ β ≦ 4 with α = 4. |
| 00011110 | (3, 4) | |
| 000111100 | (2, 4) | |
| 0001111001 | (2, 5) | UE supports 1 ≦ β ≦ 2 with α = 5. |
| 00011110010 | (1, 5) | |
| 000111100101 | (1, 6) | UE supports β = 1 with α = 6. |
| 0001111001010 | (0, 6) | |
| 00011110010101 | (0, 7) | |

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a user equipment, comprising:
generating an information element encoding a set of supported carrier combinations for the user equipment in a dual-band multi-carrier wireless communication system, the information element corresponding to a geometric representation of the set of supported carrier combinations; and
transmitting the information element on an uplink channel.

2. The method of claim 1, wherein the geometric representation comprises a grid having a first axis corresponding to a first band and a second axis corresponding to a second band, such that the grid comprises a plurality of cells, each cell of the plurality of cells representing a carrier combination in the first band and the second band.

3. The method of claim 2, wherein the information element corresponds to a boundary of a region comprising the set of supported carrier combinations in the grid.

4. The method of claim 3, wherein the information element comprises a bit sequence corresponding to a shape of the boundary, wherein a first bit value of the bit sequence corresponds to a segment of the boundary that extends along one of the plurality of cells in a first direction, and a second bit value of the bit sequence corresponds to a segment of the boundary that extends along one of the plurality of cells in a second direction orthogonal to the first direction.

5. The method of claim 4, wherein the boundary extends from a first corner of the grid to a second corner of the grid opposite the first corner.

6. The method of claim 5, wherein the information element comprises every bit of the bit sequence corresponding to the shape of the boundary from the first corner to the second corner.

7. The method of claim 5, wherein the information element comprises each bit of the bit sequence corresponding to the shape of the boundary from the first corner to the second corner, except for an ultimate segment of the boundary adjacent to the second corner.

8. The method of claim 5, wherein the set of supported carrier combinations comprises a hole in at least one of the bands, and wherein the information element comprises:
an index for indicating a boundary of the hole;
a first character corresponding to a first boundary of the hole to indicate a segment of the boundary that extends along a cell in the hole; and
a second character corresponding to a second boundary of the hole opposite the first boundary of the hole, for indicating an end of the hole.

9. A method for decoding an information element representing a set of supported carrier combinations in a dual-band multi-carrier wireless communication system, comprising:
receiving the information element from a user equipment;
initializing a two-variable counter, comprising a first variable and a second variable, to an initial value;
determining a value of a bit in the received information element; and
altering the second variable when the value of the bit is 1, and altering the first variable when the value of the bit is 0.

10. The method of claim 9, wherein the initial value corresponds to the first variable having a value corresponding to a number of carriers that may be supported on a single band in the dual-band multi-carrier wireless communication system, and the second variable having a value of zero.

11. The method of claim 10, wherein the altering of the second variable when the value of the bit is 1 comprises incrementing the second variable, and wherein the altering of the first variable when the value of the bit is 0 comprises decrementing the first variable.

12. The method of claim 11, further comprising determining a subset of supported carrier combinations corresponding the two-variable bit counter in accordance with the bit in the received information element.

13. A user equipment configured for wireless communication, comprising:
at least one processor;
a memory coupled to the at least one processor; and
a transmitter coupled to the at least one processor for transmitting an uplink channel,
wherein the at least one processor is configured to:
generate an information element encoding a set of supported carrier combinations for the user equipment in a dual-band multi-carrier wireless communication system, the information element corresponding to a geometric representation of the set of supported carrier combinations; and
transmit the information element on the uplink channel.

14. The user equipment of claim 13, wherein the geometric representation comprises a grid having a first axis corresponding to a first band and a second axis corresponding to a second band, such that the grid comprises a plurality of cells, each cell of the plurality of cells representing a carrier combination in the first band and the second band.

15. The user equipment of claim 14, wherein the information element corresponds to a boundary of a region comprising the set of supported carrier combinations in the grid.

16. The user equipment of claim 15, wherein the information element comprises a bit sequence corresponding to a shape of the boundary, wherein a first bit value of the bit sequence corresponds to a segment of the boundary that extends along one of the plurality of cells in a first direction, and a second bit value of the bit sequence corresponds to a segment of the boundary that extends along one of the plurality of cells in a second direction orthogonal to the first direction.

17. The user equipment of claim 16, wherein the boundary extends from a first corner of the grid to a second corner of the grid opposite the first corner.

18. The user equipment of claim 17, wherein the information element comprises every bit of the bit sequence corresponding to the shape of the boundary from the first corner to the second corner.

19. The user equipment of claim 17, wherein the information element comprises each bit of the bit sequence corresponding to the shape of the boundary from the first corner to the second corner, except for an ultimate segment of the boundary adjacent to the second corner.

20. The user equipment of claim 17, wherein the set of supported carrier combinations comprises a hole in at least one of the bands, and wherein the information element comprises:
an index for indicating a boundary of the hole;
a first character corresponding to a first boundary of the hole to indicate a segment of the boundary that extends along a cell in the hole; and
a second character corresponding to a second boundary of the hole opposite the first boundary of the hole, for indicating an end of the hole.

21. An apparatus for decoding an information element representing a set of supported carrier combinations in a dual-band multi-carrier wireless communication system, comprising:
at least one processor; and
a memory coupled to the at least one processor,
wherein the at least one processor is configured to:
receive the information element from a user equipment;
initialize a two-variable counter, comprising a first variable and a second variable, to an initial value;
determine a value of a bit in the received information element; and
alter the second variable when the value of the bit is 1, and alter the first variable when the value of the bit is 0.

22. The apparatus of claim 21, wherein the initial value corresponds to the first variable having a value corresponding to a number of carriers that may be supported on a single band in the dual-band multi-carrier wireless communication system, and the second variable having a value of zero.

23. The apparatus of claim 22, wherein the altering of the second variable when the value of the bit is 1 comprises incrementing the second variable, and wherein the altering of the first variable when the value of the bit is 0 comprises decrementing the first variable.

24. The apparatus of claim 23, wherein the at least one processor is further configured to determine a subset of supported carrier combinations corresponding the two-variable bit counter in accordance with the bit in the received information element.

25. A computer program product operable at a user equipment, comprising:
a computer-readable medium comprising:
instructions for causing a computer to generate an information element encoding a set of supported carrier combinations for the user equipment in a dual-band multi-carrier wireless communication system, the information element corresponding to a geometric representation of the set of supported carrier combinations; and
instructions for causing a computer to transmit the information element on an uplink channel.

26. A computer program product for decoding an information element representing a set of supported carrier combinations in a dual-band multi-carrier wireless communication system, comprising:
a computer-readable medium comprising:
instructions for causing a computer to receive the information element from a user equipment;
instructions for causing a computer to initialize a two-variable counter, comprising a first variable and a second variable, to an initial value;
instructions for causing a computer to determine a value of a bit in the received information element; and
instructions for causing a computer to alter the second variable when the value of the bit is 1, and to alter the first variable when the value of the bit is 0.

27. A user equipment configured for wireless communication, comprising:
means for generating an information element encoding a set of supported carrier combinations for the user equipment in a dual-band multi-carrier wireless communication system, the information element corresponding to a geometric representation of the set of supported carrier combinations; and
means for transmitting the information element on an uplink channel.

28. An apparatus for decoding an information element representing a set of supported carrier combinations in a dual-band multi-carrier wireless communication system, comprising:
means for receiving the information element from a user equipment;
means for initializing a two-variable counter, comprising a first variable and a second variable, to an initial value;
means for determining a value of a bit in the received information element; and
means for altering the second variable when the value of the bit is 1, and altering the first variable when the value of the bit is 0.
